(19) United States
(12) Patent Application Publication
(10) Pub. No.: US 2024/0086149 A1
(43) Pub. Date: Mar. 14, 2024

(54) CONSTRAINED CLUSTERING ALGORITHM FOR EFFICIENT HARDWARE IMPLEMENTATION OF A DEEP NEURAL NETWORK ENGINE

(71) Applicant: SK hynix Inc., Gyeonggi-do (KR)

(72) Inventors: Fan ZHANG, Fremont, CA (US); Seyhan KARAKULAK, San Jose, CA (US); Haobo WANG, San Jose, CA (US); Meysam ASADI, Fremont, CA (US)

(21) Appl. No.: 17/944,805

(22) Filed: Sep. 14, 2022

(51) Int. Cl. G06F 7/499

(52) U.S. Cl. CPC G06F 7/49915

(57) ABSTRACT

A method and a system for operating a deep neural network. In the method and system, a subset of floating-point values are used to represent weights in the DNN; the floating-point values are quantized onto a flexible-power-of-two (FPoT) alphabet; values in the FPoT alphabet are listed in a plurality of regions; and an empty region among the plurality of regions is merged to neighbour regions to output dusters of the weights in merged regions, the merged regions having respective centroids and boundary lines in between.

### BACKGROUND

### 1. Field

Embodiments of the present disclosure relate to an algorithm for use in a deep neural network (DNN) engine.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices.

Memory systems using memory devices provide excellent stability, durability, high information access speed, and low power consumption, since they have no moving parts. Examples of memory systems having such advantages include universal serial bus (USB) memory devices, memory cards having various interfaces such as a universal flash storage (UFS), and solid state drives (SSDs). Memory systems may use various read thresholds to perform read operations.

Similar to that described in U.S. Patent Appl, Publ. No. 2021/0142160 A1 (the entire contents of which are incorporated herein by reference), the handling of out-of-distribution input data, such as input data that a neural network has not been trained to classify, can result in elevated classification error rates, and can use significant memory, time, or computing resources. The '160 publication describes techniques to identify out-of-distribution input data in one or more neural networks. The '160 publication trains a first portion of a neural network in a first set of data, and trains a second portion of the neural network on a second set of data.

### SUMMARY

Aspects of the present invention include a method and a memory system for operating a deep neural network (DNN).

In one aspect, there is provided a method for operating a DNN, The method comprises using a subset of floating-point values to represent weights in the DNN; quantizing the floating-point values onto a flexible-power-of-two (FPoT) alphabet; listing values in the FPoT alphabet in a plurality of regions; and merging an empty region among the plurality of regions to neighbour regions to output clusters of the weights in merged regions, the merged regions having respective centroids and boundary lines in between.

In another aspect, there is provided a memory system for operating a DNN, The memory system comprises: a data source; and a controller configured to calculate parameters corresponding to the DNN, wherein the controller is programmed to: use a subset of floating-point values to represent weights in the DNN, quantize the floating-point values onto a flexible-power-of-two (FPoT) alphabet, list values in the FPoT alphabet in a plurality of regions, and merge an empty region among the plurality of regions to neighbor regions to output dusters of the weights in merged regions, the merged regions having respective centroids and boundary lines in between.

Additional aspects of the present invention will become apparent from the following description.

### BRIEF DESCRIPTION OF THE DRAWINGS

FIG. 1. is a block diagram illustrating a data processing system in accordance with an embodiment of the present invention.

FIG. 2 is a block diagram illustrating a memory system in accordance with one embodiment of the present invention.

FIG. 3 is a circuit diagram illustrating a memory block of a memory device in accordance with another embodiment of the present invention.

FIG. 4 is a diagram illustrating distributions of states for different types of cells of a memory device.

FIG. 5A is a diagram illustrating an example of Gray coding for a multi-level cell (MLC).

FIG. 58 is a diagram illustrating state distributions for pages of a multi-level cell (MLC).

FIG. 6 is a depiction of an example error correction system based on some embodiments of the disclosed technology.

FIG. 7 illustrates an example of a deep neural network architecture for data storage performance optimization implemented based on some embodiments of the disclosed technology.

FIG. 8 illustrates an example configuration of a computational neural network including input neurons, hidden neurons, output neurons, and synapse layers.

FIG. 9A is a depiction of floating point and fixed point representations.

FIG. 98 is a depiction of a one-dimensional 1D example of a constrained clustering algorithm according to one embodiment of the present invention.

FIG. 9C is a flowchart depiction of the operation of the constrained clustering algorithm (CCA).

FIG. 10A is a depiction of a 2D example of constrained clustering algorithm.

FIG. 10B is a depiction of one of the cluster regions in FIG. 10A.

FIG. 11 illustrates an example of a deep neural network operation.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, for example including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention, Unless stated otherwise, a component such as a processor or a memory described as being suitable for performing a task may be implemented as a general device or circuit component that is configured or otherwise programmed to perform the task at a given time or as a specific device or as a circuit component that is manufactured or pre-configured or pre-programmed to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed for example by a computer, processor, controller, or other signal processing device. The computer, processor, controller, or other signal processing device may be those described herein or one in addition to the elements described herein, Because the algorithms that form the basis of the methods (or operations of the computer, processor, controller, or other signal processing device) are described herein, the code or instructions for implementing the operations of the method embodiments may transform the computer, processor, controller, or other signal processing device into a special-purpose processor for performing any one of the methods herein.

If implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of various embodiments of the present invention is provided below along with accompanying figures that illustrate aspects of the present invention. The present invention is described in connection with such embodiments, but the present invention is not limited to any specific embodiment. The present invention encompasses numerous alternatives, modifications and equivalents. Numerous specific details are set forth in the following description in order to provide a thorough understanding of the present invention. These details are provided for the purpose of example; the present invention may be practiced without some or all of these specific details. For clarity, technical material that is known in technical fields related to the present invention has not been described in detail so that the invention is not unnecessarily obscured.

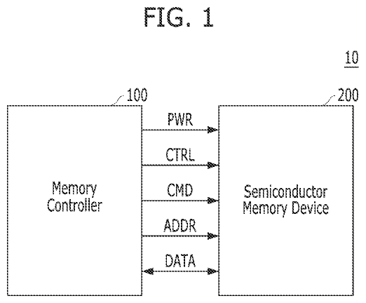

FIG. 1. is a block diagram illustrating a data processing system 2 in accordance with an embodiment of the present invention.

Referring FIG. 1, the data processing system 2 may include a host device 5 and a memory system 10. The memory system may receive a request from the host device 5 and operate in response to the received request. For example, the memory system may store data to be accessed by the host device 5.

The host device 5 may be implemented with any one of various kinds of electronic devices. In various embodiments, the host device 5 may include an electronic device such as a desktop computer, a workstation, a three-dimensional (3D) television, a smart television, a digital audio recorder, a digital audio player, a digital picture recorder, a digital picture player, and/or a digital video recorder and a digital video player. In various embodiments, the host device 5 lay include a portable electronic device such as a mobile phone, a smart phone, an e-book, an MP3 player, a portable multimedia player (PMP), and/or a portable game player.

The memory system 10 may be implemented with any one of various kinds of storage devices such as a solid state drive (SSD) and a memory card. In various embodiments, the memory system 10 may be provided as one of various components in an electronic device such as a computer, an ultra-mobile personal computer (PC) (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, a radio-frequency identification (RFID) device, as well as one of various electronic devices of a home network, one of various electronic devices of a computer network, one of electronic devices of a telematics network, or one of various components of a computing system.

The memory system 10 may include a memory controller 100 and a semiconductor memory device 200. The memory controller 100 may control overall operations of the semiconductor memory device 200.

The semiconductor memory device 200 may perform one or more erase, program, and read operations under the control of the memory controller 100. The semiconductor memory device 200 may receive a command CMD, an address ADDR and data DATA through input/output lines. The semiconductor memory device 200 may receive power PWR through a power line and a control signal CTRL through a control line. The control signal CTRL may include a command latch enable signal, an address latch enable signal, a chip enable signal, a write enable signal, a read enable signal, as well as other operational signals depending on design and configuration of the memory system 10.

The memory controller 100 and the semiconductor memory device 200 may be integrated in a single semiconductor device such as a solid state drive (SSD). The SSD may include a storage device for storing data therein. When the semiconductor memory system 10 is used in an SSD, operation speed of a host device (e.g., host device 5 of FIG. 1) coupled to the memory system 10 may remarkably improve.

The memory controller 100 and the semiconductor memory device 200 may be integrated in a single semiconductor device such as a memory card. For example, the memory controller 100 and the semiconductor memory device 200 may be so integrated to configure a personal computer (PC) card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), and/or a universal flash storage (UFS).

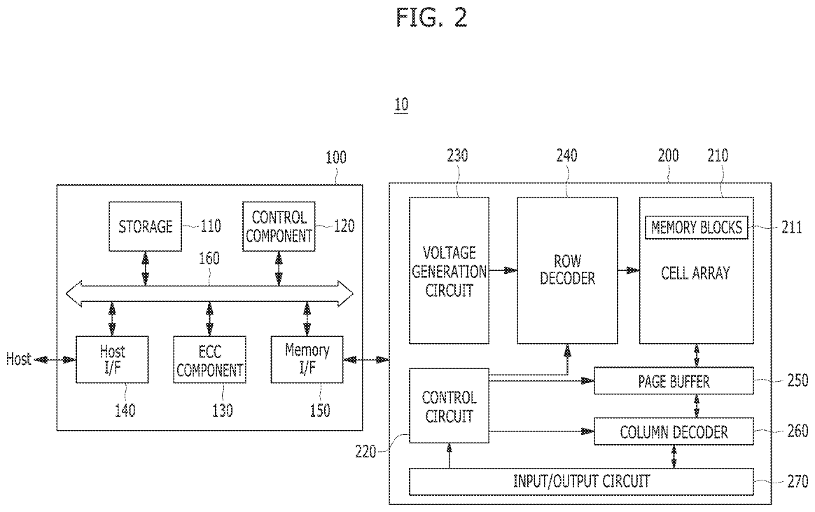

FIG. 2 is a block diagram illustrating a memory system in accordance with an embodiment of the present invention. For example, the memory system of FIG. 2 may depict the memory system 10 shown in FIG. 1.

Referring to FIG. 2, the memory system 10 may include a memory controller 100 and a semiconductor memory device 200. The memory system 10 may operate in response to a request from a host device (e.g., host device 5 of FIG. 1), and in particular, store data to be accessed by the host device.

The memory device 200 may store data to be accessed by the host device.

The memory device 200 may be implemented with a volatile memory device such as a dynamic random access memory (DRAM) and/or a static random access memory (SRAM) or a non-volatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), and/or a resistive RAM (RRAM).

The controller 100 may control storage of data in the memory device 200. For example, the controller 100 may control the memory device 200 in response to a request from the host device. The controller 100 may provide data read from the memory device 200 to the host device, and may store data provided from the host device into the memory device 200.

The controller 100 may include a storage 110, a control component 120, which may be implemented as a processor such as a central processing unit (CPU), an error correction code (ECC) component 130, a host interface (I/F) 140 and a memory interface (I/F) 150, which are coupled through a bus 160.

The storage 110 may serve as a working memory of the memory system 10 and the controller 100, and store data for driving the memory system 10 and the controller 100, When the controller 100 controls operations of the memory device 200, the storage 110 may store data used by the controller 100 and the memory device 200 for such operations as read, write, program and erase operations.

The storage 110 may be implemented with a volatile memory such as a static random access memory (SRAM) or a dynamic random access memory (DRAM). As described above, the storage 110 may store data used by the host device in the memory device 200 for the read and write operations. To store the data, the storage 110 may include a program memory, a data memory, a write buffer, a read buffer, a map buffer, and the like.

The control component 120 may control general operations of the memory system 10, and a write operation or a read operation for the memory device 200, in response to a write request or a read request from the host device. The control component 120 may drive firmware, which is referred to as a flash translation layer (FTL), to control general operations of the memory system 10. For example, the FTL may perform operations such as logical-to-physical (L2P) mapping, wear leveling, garbage collection, and/or bad block handling. The L2P mapping is known as logical block addressing (LBA).

The ECC component 130 may detect and correct errors in the data read from the memory device 200 during the read operation. The ECC component 130 may not correct error bits when the number of the error bits is greater than or equal to a threshold number of correctable error bits, and instead may output an error correction fail signal indicating failure in correcting the error bits.

In various embodiments, the ECC component 130 may perform an error correction operation based on a coded modulation such as a low density parity check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), or a Block coded modulation (BCM), However, error correction is not limited to these techniques. As such, the ECC component 130 may include any and all circuits, systems or devices for suitable error correction operation.

The host interface 140 may communicate with the host device through one or more of various interface protocols such as a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (DATA), an enhanced small disk interface (ESDI), and an integrated drive electronics (IDE).

The memory interface 150 may provide an interface bet teen the controller 100 and the memory device 200 to allow the controller 100 to control the memory device 200 in response to a request from the host device. The memory interface 150 may generate control signals for the memory device 200 and process data under the control of the control component 120, When the memory device 200 is a flash memory such as a NAND flash memory, the memory interface 150 may generate control signals for the memory and process data under the control of the control component 120.

The memory device 200 may include a memory cell array 210, a control circuit 220, a voltage generation circuit 230, a row decoder 240, a page buffer 250, which may be in the form of an array of page buffers, a column decoder 260, and an input and output (input/output) circuit 270. The memory cell array 210 may include a plurality of memory blocks 211 which may store data. The voltage generation circuit 230, the row decoder 240, the page buffer array 250, the column decoder 260 and the input/output circuit 270 may form a peripheral circuit for the memory cell array 210. The peripheral circuit may perform a program, read, or erase operation of the memory cell array 210. The control circuit 220 may control the peripheral circuit.

The voltage generation circuit 230 may generate operation voltages of various levels. For example, in an erase operation, the voltage generation circuit 230 may generate operation voltages of various levels such as an erase voltage and a pass voltage.

The row decoder 240 may be in electrical communication with the voltage generation circuit 230, and the plurality of memory blocks 211. The row decoder 240 may select at least one memory block among the plurality of memory blocks 211 in response to a row address generated by the control circuit 220, and transmit operation voltages supplied from the voltage generation circuit 230 to the selected memory blocks.

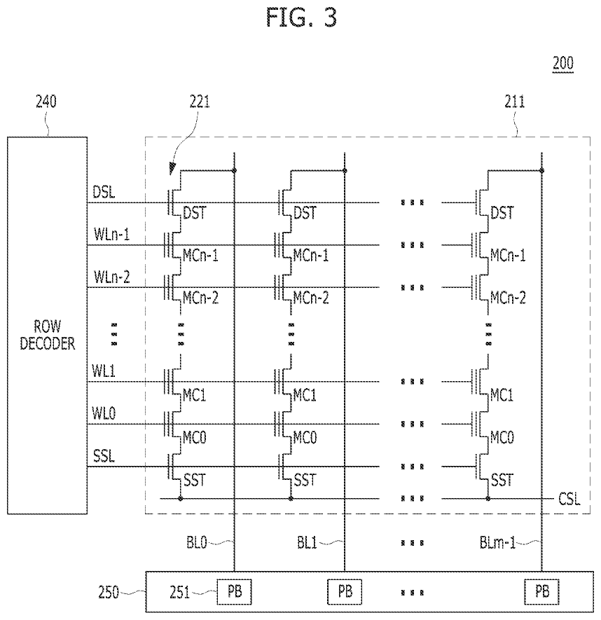

The page buffer 250 may be coupled with the memory cell array 210 through bit lines BL (shown in FIG. 3). The page buffer 250 may precharge the bit lines BL with a positive voltage, transmit data to, and receive data from, a selected memory block in program and read operations, or temporarily store transmitted data, in response to page buffer control signal(s) generated by the control circuit 220.

The column decoder 260 may transmit data to, and receive data from, the page buffer 250 or transmit and receive data to and from the input/output circuit 270.

The input/output circuit 270 may transmit to the control circuit 220 a command and an address, received from an external device (e.g., the memory controller 100 of FIG. 1), transmit data from the external device to the column decoder 260, or output data from the column decoder 260 to the external device, through the input/output circuit 270.

The control circuit 220 may control the peripheral circuit in response to the command and the address.

FIG. 3 is a circuit diagram illustrating a memory block of a semiconductor memory device in accordance with an embodiment of the present invention. For example, the memory block of FIG. 3 may be any of the memory blocks 211 of the memory cell array 210 shown in FIG. 2.

Referring to FIG. 3, the exemplary memory block 211 may include a plurality of word lines WL0 to WLn-1, a drain select line DSL and a source select line SSL coupled to the row decoder 240. These lines may be arranged in parallel, with the plurality of word lines between the DSL and SSL.

The exemplary memory block 211 may further include a plurality of cell strings 221 respectively coupled to bit lines BL0 to BLm-1, The cell string of each column may include one or more drain selection transistors DST and one or more source selection transistors SST. In the illustrated embodiment, each cell string has one DST and one SST. In a cell string, a plurality of memory cells or memory cell transistors MC0 to MCn-1 may be serially coupled between the selection transistors DST and SST. Each of the memory cells may be formed as a multiple level cell. For example, each of the memory cells may be formed as a single level cell (SLC) storing 1 bit of data. Each of the memory cells may be formed as a mufti-level cell (MLC) storing 2 bits of data. Each of the memory cells may be formed as a triple-level cell (TLC) storing 3 bits of data. Each of the memory cells nay be formed as a quadruple-level cell (QLC) storing 4 bits of data.

The source of the SST in each cell string may be coupled to a common source line CSL, and the drain of each DST may be coupled to the corresponding bit line, Gates of the SSTs in the cell strings may be coupled to the SSL, and gates of the DSTs in the cell strings may be coupled to the DSL. Gates of the memory cells across the cell strings may be coupled to respective word lines. That is, the gates of memory cells MC0 are coupled to corresponding word line WL0, the gates of memory cells MC1 are coupled to corresponding word line WL1, etc. The group of memory cells coupled to a particular word line may be referred to as a physical page. Therefore, the number of physical pages in the memory block 211 may correspond to the number of word lines.

The page buffer array 250 may include a plurality of page buffers 251 that are coupled to the bit lines BL0 to BLm-1. The page buffers 251 may operate in response to page buffer control signals. For example, the page buffers 251 may temporarily store data received through the bit lines BL0 to BLm-1 or sense voltages or currents of the bit lines during a read or verify operation.

In some embodiments, the memory blocks 211 may include a NAND-type flash memory cell. However, the memory blocks 211 are not limited to such cell type, but may include NOR-type flash memory cell(s). Memory cell array 210 may be implemented as a hybrid flash memory in which two or lore types of memory cells are combined, or one-NAND flash memory in which a controller is embedded inside a memory chip.

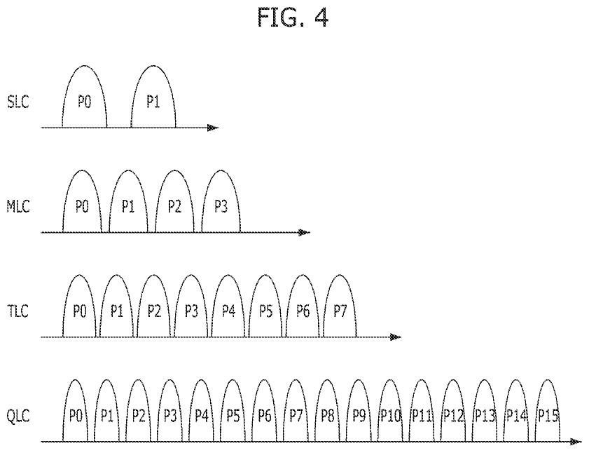

FIG. 4 is a diagram illustrating distributions of states or program voltage (PV) levels for different types of cells of a memory device.

Referring to FIG. 4, each of memory cells may be implemented with a specific type of cell, for example, a single level cell (SLC) storing 1 bit of data, a multi-level cell (MLC) storing 2 bits of data, a triple-level cell (TLC) storing 3 bits of data, or a quadruple-level cell (QLC) storing 4 bits of data. Usually, all memory cells in a particular memory device are of the same type, but that is not a requirement.

An SLC may include two states P0 and P1. P0 may indicate an erase state, and P1 may indicate a program state. Since the SLC can be set in one of two different states, each SLC may program or store 1 bit according to a set coding method. An MLC may include four states P0, P1, P2 and P3, Among these states, P0 may indicate an erase state, and P1 to P3 may indicate program states. Since the MLC can be set in one of four different states, each MLC may program or store two bits according to a set coding method, A TLC may include eight states P0 to P7. Among these states, P0 may indicate an erase state, and P1 to P7 may indicate program states, Since the TLC can be set in one of eight different states, each TLC may program or store three bits according to a set coding method. A QLC may include 16 states P0 to P15. Among these states, P0 may indicate an erase state, and P1 to P15 may indicate program states. Since the QLC can be set in one of sixteen different states, each QLC may program or store four bits according to a set coding method.

Referring back to FIGS. 2 and 3, the memory device 200 may include a plurality of memory cells (e.g., NAND flash memory cells), The memory cells are arranged in an array of rows and columns as shown in FIG. 3, The cells in each row are connected to a word line (e.g., WL0), while the cells in each column are coupled to a bit line (e.g., BL0). These word and bit lines are used for read and write operations. During a write operation, the data to be written (‘1’ or ‘0’) is provided at the bit line while the word line is asserted, During a read operation, the word line is again asserted, and the threshold voltage of each cell can then be acquired from the bit line. Multiple pages may share the memory cells that belong to (i.e., are coupled to) the same word line. When the memory cells are implemented with MLCs, the multiple pages include a most significant bit (MSB) page and a least significant bit (LSB) page. When the memory cells are implemented with TLCs, the multiple pages include an MSB page, a center significant bit (CSB) page and an LSB page. When the memory cells are implemented with QLCs, the multiple pages include an MSB page, a center most significant bit (CMSB) page, a center least significant bit (CLSB) page and an LSB page. The memory cells may be programmed using a coding scheme (e.g., Gray coding) in order to increase the capacity of the memory system 10 such as SSD.

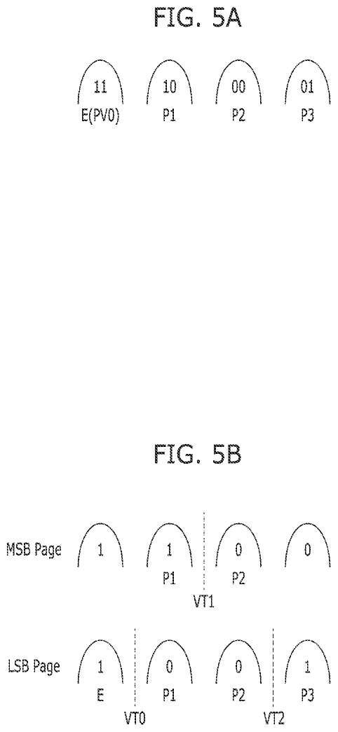

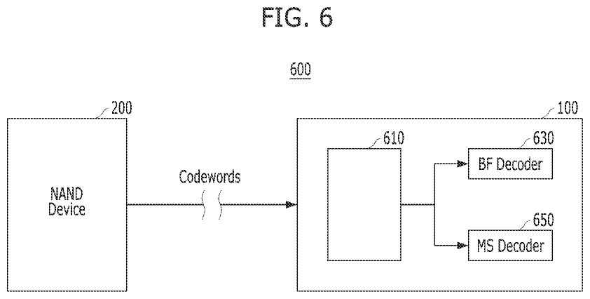

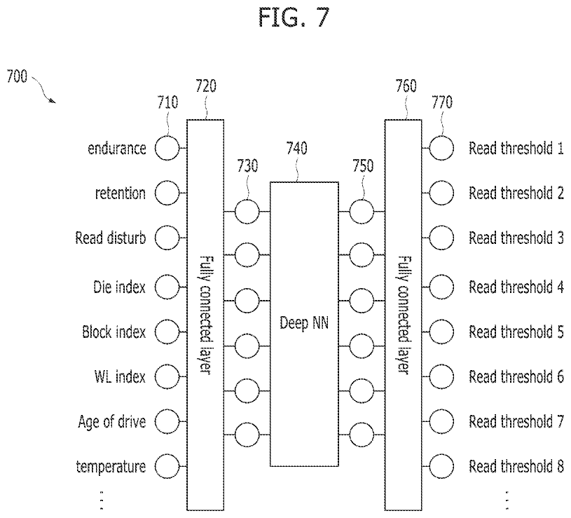

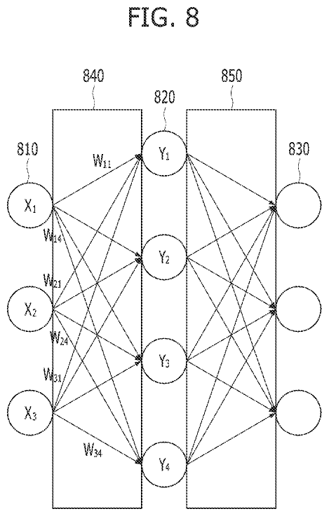

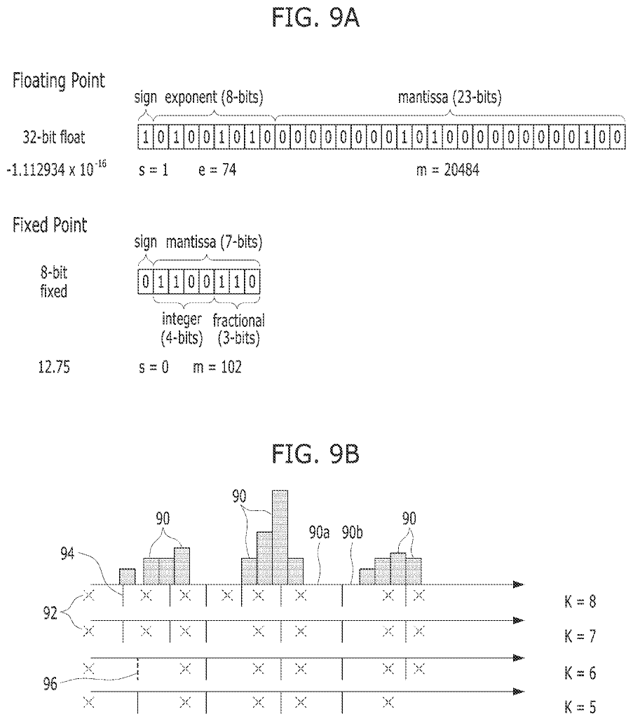

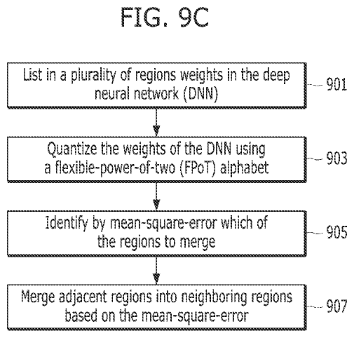

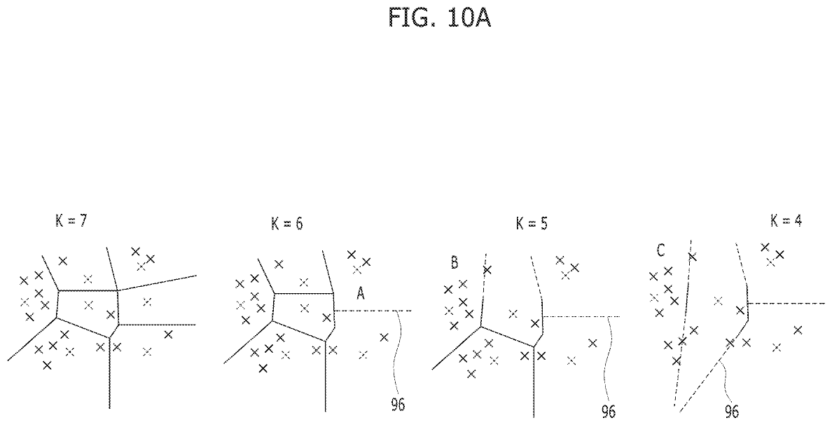

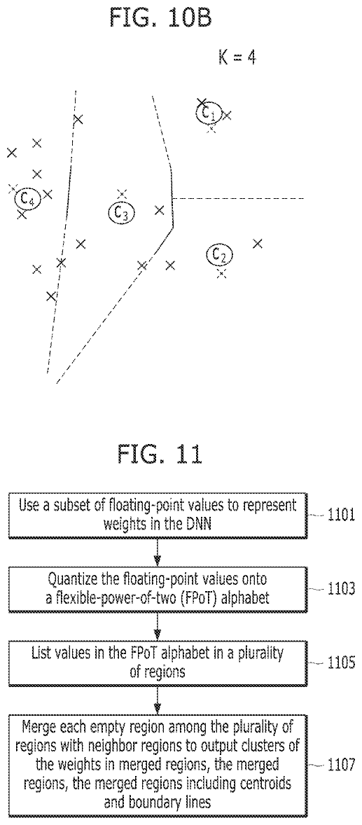

FIG. 5A is a diagram illustrating an example of coding for a multi-level cell (MLC).

Referring to FIG. 5A, an MLC may be programmed using a set coding. An MLC may have 4 program states, which include an erased state E (or PV0) and a first program state PV1 to a third program state PV3, The erased state E (or PV0) may correspond to “11.” The first program state PV1 may correspond to “10.” The second program state PV2 may correspond to “00.” The third program state PV3 may correspond to “01.”

In the MLC, as shown in FIG. 5B, there are 2 types of pages including LSB and MSB pages. 1 or 2 thresholds may be applied in order to retrieve data from the MLC. For an MSB page, the single threshold value is VT1. VT1 distinguishes between the first program state PV1 and the second program state PV2, For an LSB page, 2 thresholds include a threshold value VT0 and a threshold value VT2. VT0 distinguishes between the erased state E and the first program state PV1. VT2 distinguishes between the second program state PV2 and the third program state PV3.

In a further example, a triple-level cell (TLC) may be programmed using Gray coding. A TLC may have 8 program states, which include an erased state E (or PV0) and a first program state PV1 to a seventh program state PV7, The erased state E (or PV0) may correspond to “110.” The first program state PV1 may correspond to “011.” The second program state PV2 may correspond to “001.” The third program state PV3 may correspond to “000.” The fourth program state PV4 may correspond to “010.” The fifth program state PV5 may correspond to “110.” The sixth program state PV6 may correspond to “100.” The seventh program state PV7 may correspond to “101.” In the TLC, 2 or 3 thresholds may be applied in order to retrieve data from the TLC.

After a memory array including a plurality of memory cells is programmed, when a read operation is performed on the memory array using a certain voltage reference value such as a read threshold (i.e., read voltage level), the electrical charge levels of the memory cells (e.g., threshold voltage levels of transistors of memory cells) are compared to one or more voltage reference values (also called “read voltage level” or “read threshold”) to determine the state of individual memory cells. When a certain read threshold is applied to the memory array, those memory cells that have threshold voltage levels higher than the certain voltage reference value are turned on and detected as “on” cell, whereas those memory cells that have threshold voltage levels lower than the certain voltage reference value are turned off and detected as “off” cell, for example. Therefore, each read threshold is arranged between neighboring threshold voltage distribution windows corresponding to different programmed states so that each read threshold can distinguish such programmed states by turning on or off the memory cell transistors.

When a read operation is performed on memory cells in a data storage device using MLC technology, the threshold voltage levels of the memory cells are compared to more than one read threshold level to determine the state of individual memory cells. Read errors can be caused by distorted or overlapped threshold voltage distribution. An ideal memory cell threshold voltage distribution can be significantly distorted or overlapped due to, e.g., program and erase (PIE) cycle, cell-to-cell interference, and data retention errors. For example, as program/erase cycles increase, the margin between neighboring threshold voltage distributions of different programmed states decreases and eventually the distributions start overlapping. As a result, the memory cells with threshold voltages that fall within the overlapping range of the neighboring distributions may be read as being programmed to a value other than the original targeted value and thus cause read errors. Such read errors may be managed in most situations by using error correction codes (ECC). When the number of bit errors on a read operation exceeds the ECC correction capability of the data storage, the read operation fails.

Certain circumstances or operation conditions, such as charge leakage over time and device usage wear, can cause threshold voltages shift. Such a threshold voltage shift can produce read errors because several “off” cells may result in a threshold voltage higher than the read threshold due to the threshold voltage shift. Various circumstances can cause the threshold voltage shift to produce read errors. For example, memory devices with low endurance can produce more read errors than those with high endurance, Such a threshold voltage shift can be induced by operating conditions such as increased number of program/erase cycles of the memory array and increased operating temperature of the data storage devices A read disturbance and the location of a memory chip or memory block may also be considered to determine whether the threshold voltage shift is likely to occur.

The endurance of a flash memory may indicate the maximum number of program/erase operations that the flash memory is able to perform successfully. Each memory cell can only be programmed and erased a limited number of times, before it becomes potentially unusable. In some embodiments of the disclosed technology, the endurance of a flash memory indicates the maximus number of program/erase operations per set period, e,g., day. The endurance of the flash memories can be affected by structural issues such as high memory densities and operating conditions such as high program voltages.

Data retention may refer to an operating condition relating to how long memory cells maintain a correct programmed state, Data retention can vary depending on the operating temperature and the number of program/erase cycles performed on the memory cells. Subjecting memory cells subject to high temperature and a large number of program/erase operations tends to lower their data retention.

The read disturbance indicates a phenomenon where reading data from a flash cell can cause the threshold voltages of other unread cells in the same block to shift to a different (e.g., higher) value. While a single threshold voltage shift is small, when read operations are performed over time, the threshold voltage shift eventually becomes large enough to alter the states of the memory cells.

Die, block and word line indices can represent the physical location of the memory cell to be read, A data storage device can be made up of a plurality of memory chip dies, each including a plurality of memory blocks, Each memory block includes a plurality of memory cells, and each memory cell can be selected by a word line coupled thereto. A memory controller can be configured to track movement of data across the plurality of dies and the plurality of blocks. Based on the movement of data, the memory controller can determine how many program/erase operations a certain memory die or a certain memory block has performed. This information can be stored with reference to die indices, block indices, and word line indices to identify location(s) where program/erase operations is/are concentrated. The possibility of read errors would be higher when reading out data from any of those locations.

Such read errors, however, can be minimized by modifying the read thresholds. In some embodiments of the disclosed technology, the read thresholds may be modified based on operating conditions that contribute to the read errors in flash memory-based data storage SSD devices. These operating conditions include, but are not limited to, the endurance of a memory device, data retention, read disturbance, age of the associated storage device, operating temperature of the data storage device, and the location of the memory cell to be read, which can be indicated by die indices, block indices, and/or word line indices.

Generally, an SSD can be a storage device that stores data persistently or caches data temporarily in nonvolatile semiconductor memory and is intended for use in storage systems, servers (e.g., within data-centers), and direct-attached storage (DAS) devices. A growing number of applications need high data throughput and low transaction latency and SSDs are used as a viable storage solution to increase the performance, efficiency, reliability and lowering overall operating expenses. SSDs generally use NAND flash memory and deliver higher performance and consume less power than spinning hard-disk drives (HDDs). NAND Flash memory has a number of inherent issues associated with it, the two most important include a finite life expectancy as NAND Flash cells wear out during repeated writes, and a naturally occurring error rate. SSDs can be designed and manufactured according to a set of industry standards that define particular performance specifications, including latency specifications, to support heavier write workloads, more extreme environmental conditions and recovery from a higher bit error rate (BER) than a client SSD (e.g., personal computers, laptops, and tablet computers).

FIG. 6 illustrates an example error correction system 500 that includes multiple decoders, in accordance with certain embodiments of the present disclosure. Such an error correction system is described in U.S. Pat. No. 10,700,706, entitled “MEMORY SYSTEM WITH DECODERS AND METHOD OF OPERATING SUCH MEMORY SYSTEM AND DECODERS” (the entire contents of which are incorporated herein by reference).

The error correction system 600 can be included in a memory device, such as semiconductor memory device 200 of FIG. 2, In turn, the error correction system 600 includes a controller 610, a bit flipping (BF) decoder 630, and a min-sum decoder 650. The controller 610 determines which of the two decoders 630 and 650 are to be used to decode different codewords based on an estimate of the number of raw bit-errors for each of the codewords. The bit-errors can be due to noise and, accordingly, the codewords can be noisy codewords. The BF decoder 630 outputs decoded bits corresponding to one or more of the codewords, where the decoded bits remove some or all of the noise (e.g., correct the error bits). Similarly, the decoder 650 outputs decoded bits corresponding to remaining one or more of the codewords where the decoded bits remove some or all of the noise (e.g., correct the error bits).

If the controller 610 determines that a codeword has a severe bit error rate, a decoding failure is likely with the two decoders 630 and 650, Otherwise, the codeword can be dispatched to the BF decoder 630 when the controller 610 determines that the bit-error rate falls into the BF correction capability. Alternatively, the codeword can be dispatched to the MS decoder 650 when the controller 610 determines that the bit-error rate is outside of the BF correction capability. Dispatching the codeword includes storing the codeword into one of the memory buffers.

The performance (e.g., input/output operations per second and throughput) of a data storage device such as an SSD is heavily dependent on the read threshold setting (i.e., read voltage setting) applied when the first read operation is conducted. If the read threshold is not optimized, the performance may be degraded because such unoptimized read threshold voltages can cause read errors. The optimization of the read threshold voltages depends on certain operating conditions such as physical location of data, device endurance, data retention time, operating temperature, read disturbance, and age of device. However, it is unrealistic to manually consider all the possible combinations of different operating conditions to modify the read thresholds. It would be even more difficult to manually obtain an optimized read threshold if the operating conditions change often. Accordingly, it is desirable to provide a system and a method for optimizing read threshold values using deep learning, One implementation of deep learning has a structure as shown in FIGS. 7 and 8. Such a structure is described in U.S. patent application Ser. No. 16/717,888, entitled “STORAGE DEVICE PERFORMANCE OPTIMIZATION USING DEEP LEARNING” and incorporated by reference herein.

In some embodiments of the disclosed technology, the read errors can be minimized by using a deep neural network to identify specific effects of threshold voltage shift that can occur in a memory cell array of a data storage device based on the operating conditions discussed above. In some implementations of the disclosed technology operating conditions that contribute to the threshold voltage shifts, which can result in the read errors, are classified and such operating conditions are quantified using a deep neural network. Some implementations of the disclosed technology include identifying criteria that must be met to set a read threshold at a certain value. For example, when it is determined that the criteria for the optimal read threshold is not met (e.g., when the number of errors or indication of errors from the memory device approaches an undesirably high value, a temperature value approaches a low or a high threshold value, etc.), a memory controller can obtain new values to modify the read thresholds based on the sensed operating conditions using the values that is generated by the deep learning neural network engine. The operating conditions, including a physical location of data, an endurance of the data storage device, data retention, an operating temperature, a read disturbance, and the age of the data storage device, can be used to estimate or predict the threshold voltage shift. The deep neural network may be trained based on input data collected from a large number of flash memory chip dies. For example, the deep neural network can be trained based on a limited combination of operating conditions. In an implementation, optimized read threshold voltages are computed from the trained deep neural network engine. In another implementation, the values obtained by the trained neural network engine may be stored in a memory (e.g., a lookup table) of a data storage device, and a memory controller in the data storage device may modify the read threshold voltages based on the values.

In some embodiments of the disclosed technology, a deep neural network is used to predict the optimal read threshold from the operating conditions of the storage device. In one example, the deep learning network can be used to interpolate the optimal read thresholds associated with operating conditions that do not exist in the training data set obtained from the offline memory device characterization. In some embodiments of the disclosed technology, a trained deep neural network for optimizing read threshold voltages can be obtained from an offline computing process based on a limited combination of operating conditions. Based on a larger set of operating conditions, the optimal read thresholds for all possible combinations of operating conditions can be computed by the trained deep learning network so that the optimization results may be used during actual read operations of the memory device.

In some embodiments of the disclosed technology, the control component 120 drives firmware which operates a deep neural network (DNN) using a constrained clustering algorithm (described in detail below) permitting the precision of the weights of the DNN to be reduced without losing accuracy of the DNN prediction and thereby providing faster data analysis of parameters associated with data reading, storage, encoding, decoding, logical-to-physical (L2P) mapping, wear leveling, garbage collection, bad block handling, data retention (including the above noted operating conditions such as number of program/erase cycles, the operating temperature, the number of program/erase cycles performed on the memory cells) relating to how long memory cells maintain a correct programmed state, etc.

FIG. 7 illustrates an example of a deep neural network architecture for data storage performance optimization implemented based on various embodiments of the disclosed technology. The deep neural network architecture 700 for data storage performance optimization includes a plurality of input nodes 710, first and second connection layers 720 and 760, a plurality of connection nodes 730 and 750, and a deep neural network 740, and a plurality of output nodes 770. Here, the first and second connection layers 720 and 760 may be fully connected layers. For example, the first connection layer 720 may be configured to connect all the input nodes 710 to all the connection nodes 730 of the deep neural network 740. Likewise, the second connection layer 760 may be configured to connect all the output nodes 770 to all the connection nodes 750 of the deep neural network 740. In some embodiments of the disclosed technology, the input and output nodes 710 and may be input neurons and output neurons, and the first and second connection layers 720 and 760 may be synapse layers, as will be discussed below.

An already-trained deep neural network 740, through the plurality of input nodes 710, the first connection layer 720, and the first connection nodes 730, receives the operating conditions that contribute to the read performance such as endurance, retention, read disturbance, die index, block index, word line index, age of the data storage drive, and/or temperature. In one example, the deep neural network 740 measures data in the memory devices under combinations of operating conditions using a set of read thresholds. For example, the deep neural network 740 may read out data from a certain memory cell of the data storage device under the combination of the operating conditions, including the endurance of the memory device the certain memory cell belongs to, the data retention of the memory device the certain memory cell belongs to, an expected read disturbance associated with the certain memory cell, the age of the data storage, the operating temperature of the data storage, and the physical location of the certain memory cell, which can be determined based on the die index, the block index, and the word line index. For operating conditions with continuous values, some implementation examples of the disclosed deep neural network only select or extract discrete values. In this way, the optimal read threshold can be obtained from the already-trained deep neural network. In one implementation, the thresholds voltages optimized corresponding to each combination of operating conditions may be stored in a memory (e.g., SRAM) of the storage device.

In another example, the already-trained deep neural network 740, through the plurality of input nodes 710, the first connection layer 720, and the first connection nodes 730, receives the operating conditions that contribute to the encoding/decoding performance such as endurance, retention, read disturbance, die index, block index, word line index, age of the data storage drive, and/or temperature.

In another example, the already-trained deep neural network 740, through the plurality of input nodes 710, the first connection layer 720, and the first connection nodes 730, receives the operating conditions that contribute to the performance of wear leveling, garbage collection, bad block handling, data retention such as endurance, retention, read disturbance, die index, block index, word line index, age of the data storage drive, and/or temperature.

FIG. 8 illustrates an example configuration of a computational neural network including input neurons 810, hidden neurons 820, output neurons 830, and synapse layers 840 and 850. For example, the synapse layer 840 may include a plurality of weights W₁₁/W₁₂/W₁₃/W₁₄/W₂₁, W₂₂, W₂₃, W₂₄, W₃₁, W₃₂, W₃₃, and W₃₄. The input neurons 810 receive some values and propagate them to the hidden neurons 820 of the network. The weighted sums from one or more layers of hidden neurons 820 are ultimately propagated to the output neurons 830. Here, the outputs of the neurons are often referred to as activations, and the synapses are often referred to as weights. An example of the computation at each layer can be expressed as:

Yj=f(Σᵢ₌₁³,Wij×Xi+b) (Eq. 1)

where Wji, Xi and Yj are the weights, input activations and output activations, respectively.

In some embodiments of the disclosed technology, input parameters such as endurance, retention, read disturbance, die index, block index, word line index, age of the data storage drive, and temperature are fed into the first layer of a deep neural network, and the outputs of that layer can be interpreted as representing the presence of different features that contribute to the threshold voltage shifts or other operational variations over time. At subsequent layers, these features are then combined into a measure of the likely presence of higher level features, which are further combined to provide a probability that these high-level features require read threshold modifications.

In some embodiments of the disclosed technology, the neural network algorithm for data storage performance optimization includes determining the value of the weights (and bias) in the neural network and is referred to as training the network. The object of training is to find the values of the weights which can make the network output (predicted value) be the same as or closed to a fitting target (data). A Mean Square Error (MSE) may be generated by squaring the individual output differences with the expected value for that output, and averaging or summing these squares for all outputs.

Once trained, the program can perform its task by computing the output of the neural network using the weights determined during the training process. Running the program with these weights is referred to as inference. There are multiple ways to train the weights. A supervised learning is an approach where all the training samples are labeled, Unsupervised learning is another approach where all the training samples are not labeled and essentially the goal is to find the structure or clusters in the data. A semi-supervised learning falls in between the two approaches where only a small subset of the training data is labeled.

The most computationally intensive operation in the training and inference of deep neural networks is the multiply-accumulate (MAC) operation. In computing, especially digital signal processing, the multiply-accumulate operation is a common step that computes the product of two numbers and adds that product to an accumulator. The hardware unit that performs the operation is known as a multiplier-accumulator (MAC, or MAC unit); the operation itself is also often called a MAC or a MAC operation.

In some embodiments of the disclosed technology, a deep learning neural network inference engine is provided for improved data storage performance optimization in order to help identify the most influential operating conditions. In one embodiment of the present invention, machine learning techniques can be utilized for example to decide optimized read thresholds or optimized codewords for decoding and encoding in the presence of noise.

### Constrained Clustering Algorithm

In a power-limited device such as an SSD or a cell phone, low precision fixed point implementation of a deep-learning inference engine is preferred due to the deep-learning inference engine typical savings in gate-count, area, power and latency. In one embodiment of the present invention, an inventive clustering algorithm for flexible-power-of-two (FPoT) non-uniform quantization scheme is used along with an architecture for the multiplier-accumulate computation (MAC) described above. With the inventive constrained clustering algorithm, the precision of the weights of the DNN can be reduced for example by half without losing accuracy of the DNN prediction.

The FPoT non-uniform quantization scheme is described in more detail below. A typical floating point and fixed point representation for weights in a DNN is shown in FIG. 9A. For all the values that a floating point number can represent, there are some values that can lead to a simple multiplication operation. For example, for some floating point numbers, if the floating point number x (multiplicand) is multiplied to ⅛ (multiplier), one can simply subtract the exponent (including the sign) by 3 to obtain the resultant product, Meanwhile, for some fixed point numbers, if a fixed point number x (multiplicand) is multiplied to 118 (multiplier), one can simply right-shift the mantissa of the multiplicand by 3 (with zero-padding to the left) to obtain the resultant product. All the values that preserve this property can be considered to form a set S. By using only quantized weights that belong to 5, the multiplication operations can be done easily. Thus, in one embodiment of the present invention, a subset of the DNN weights can be quantized to produce weights that all belong to S.

In one embodiment of the present invention the quantization weights for a DNN inference engine proceeds as follows. Weights for the DNN are numbers used in multiplications.

Different quantization schemes are possible. In a first example, a uniform quantization is used and is expressed as

$${u}^{} ( α , b ) = α \times \{ 0 , \frac{\pm 1}{{2}^{b - 1} - 1} , \frac{\pm 2}{{2}^{b - 1} - 1} , \frac{\pm 3}{{2}^{( {2}^{k} - 2 )}} , … , \pm 1 \} ,$$

where α is a scaling factor and b is the bit resolution (e.g., target number of bits). In a second example, a PoT quantization is used and is expressed as [symbol] ^{P} (α, b)=α×{0, ±2⁻²^{^{b−1}}⁺¹, ±2⁻²^{^{b−1}}⁺², . . . , ±2⁻¹, ±1}, where a is a scaling factor and b is the bit resolution. In a third example, an adaptive power-of-two (APoT) quantization is used and is expressed as [symbol] ^{a}(γ, kn)=γ×{Σᵢ₌₀ⁿ⁻¹pᵢ}, where

$${p}_{i} ∈ \{ 0 , \frac{1}{{2}^{i}} , \frac{1}{{2}^{i + n}} … , \frac{1}{{a}^{i + ( {2}^{k} - 2 ) n}} \} ,$$

where γ is a scaling factor, and where k and n are integers. In a fourth example, an FPoT quantization is used and is expressed as [symbol] ^{f}(β, r, k)=β×S,S⊂C,C={Σᵢ₌₀ⁿ⁻¹pᵢ}, where

$${p}_{i} ∈ \{ 0 , 1 , \frac{1}{{2}^{1}} , \frac{1}{{2}^{2}} , … , \frac{1}{{2}^{( {2}^{k} - 2 )}} \} ,$$

where β is a scaling factor, and where k and r are integers and k×r is the bit resolution. The output of any of these quantization examples is a quantization value per weight, where the quantization value can be represented by a bit representation, such as a floating-point representation or a fixed-point representation. Such techniques are suitable for the present invention and further described in U.S. Ser. No. 17,091,970 (the entire contents of which are incorporated herein by reference).

In the context of the FPoT non-uniform quantization scheme, this subset (i.e., the set of quantized weights) is used to represent the weights in the DNN. With these values of the quantized weights, simple multiplication operations (as described above) can sum up and shift the input value(s) to produce the resultant product. Here, the multiplying-and-accumulating (MAC) operator, as described above, may perform a multiplying calculation on the quantized weights and perform an accumulating calculation for the multiplication result. During training of the DNN, the weights in the DNN are preferably, but not necessarily, presented by the floating-point values.

As used herein, the set of values for the quantized weights is defined as the FPoT alphabet. In one embodiment of the present invention, a constrained clustering algorithm takes the floating-point weights and the FPoT alphabet as input and the output is the quantized weights which are from the FPoT alphabet. By the quantization producing a subset of all the DNN weights which are in the FPoT alphabet, the inventive technique permits efficient storage and transfer of the weights, and makes for efficient MAC computation and thus saves power.

The constrained clustering algorithm can be understood by the example shown in FIG. 93. FIG. 93 is a depiction of a one-dimensional (1D) example of a constrained clustering algorithm with K=5. The histogram of the weights of the DNN is shown as vertical rising bars 90. Regions 90a and 90b of the histogram have no weights. The crosses depicted as an “X” represent quantized values 92 in the FPoT alphabet represent a subset of all the DNN weights satisfying the quantized weight criterion of the FToP non-uniform quantization scheme.

The constrained clustering algorithm (CCA) in one embodiment of the present invention is described below. Assume that the number of clusters is limited to be up to K=5.
Step 1: List all values in the. FPoT alphabet
Step 2: The initial quantization levels are defined by the Voronoi boundaries 94 between the adjacent crosses. The values in between the two boundaries is defined as a Voronoi interval.
Step 3: Merge empty regions (which means no weights fall into this region such as the empty regions 90a and 90b shown in FIG. 9) to its left or right neighbors. Repeat step 3 until no empty region is left. If the number of regions, defined herein as k, is equal or less than K (an upper limit of k), terminate the algorithm and output the centroids (central point of each duster) and the boundary to the deep neural network. If k>K, go to step 4.
Step 4: Identify the best region (for example in terms of mean-square-error (MSE)), out of the k remaining regions, to merge, and identify the best direction to merge (for example which direction to the left or to the right results in the lowest MSE of the two directions). Merge the best region toward the best direction and repeat step 4 until k=K. Then terminate the algorithm and output the centroids and boundary lines.

The CCA algorithm above is considered optimum in that it minimizes the MSE given the number of dusters to be used. Step 2 basically makes sure that the quantization achieves a minimum MSE if all FPoT values are legitimate quantization levels (i.e., those that satisfy the quantized weight criterion of the FToP non-uniform quantization scheme.

Step 3 does not change the MSE. In Step 4, every merge operation is done in a way that MSE is minimized. So the final result of the constrained clustering algorithm is optimum, and a minimum MSE is achieved.

FIG. 9C is a flowchart depiction of the operation of the constrained clustering algorithm (CCA). At 901, list in a plurality of regions weights in the deep neural network (DNN). At 903, quantize the weights of the DNN using a flexible-power-of-two (FPoT) alphabet. At 905, identify by mean-square-error which of the regions to merge. At 909, merge adjacent regions into neighboring regions based on the mean-square-error.

Speed-up by Local MSE Calculation: Step 4 determines the best region and the best direction by calculating a new MSE if the merge is either left or right, which takes time to find the best region out of the k remaining regions, to calculate new MSEs for both directions for each of the remaining regions, and to then decide which direction is best. In one embodiment of the present invention, the calculation is speed up by only calculating the change to the MSE for two adjacent regions.

Boundary Re-Adjustment: In step 4, whenever two non-empty regions are merged, the boundary lines in between this new region and its left and right neighbouring regions are adjusted. For example, if two regions A and B (with centroids a and b) are merged, and if the centroid of B, or b, is chosen as the new centroid of AB, then the boundary in between AB and the left neighbour of A, suppose say C (with centroid c), needs to be set to the middle point of b and c. If the merge of A and B chooses centroid of A, or a, as the new centroid, the boundary between B and B's right neighbour, say D (with centroid d), needs to be changed to the middle point between a and d. In FIG. 9, this adjustment is shown as the boundary 94 in the k=7 constraint example being shifted to the right to become the dashed vertical line 96 shown in FIG. 9A.

In one embodiment of the present invention, the CCA can be applied to two-dimensional 2D or higher dimensional cases. FIG. 10A is a depiction of a 2D example of constrained clustering algorithm with K=4. In the far-left depiction, there are seven (7) non-zero weight regions, separated by the boundary lines shown. In the next depiction to the right, two adjacent regions have been consolidated forming the region depicted as A, and the new dashed boundary line 96 is shown. A further consolidation is made with the new consolidated region for K=5 being depicted as B, with new dashed boundary lines being formed because of the shift in centroids, Finally, in the far-right depiction, only four (4) regions with clusters of weights exist with last consolidated region for K=4 being depicted as C. As an example, the far-right depiction of FIG. 10A has been expanded in FIG. 10B to show centroids c1, c2, c3, and c4 with dashed boundary lines separate the clusters in each region.

### Application of CCA to the MAC Architecture

Application of the CCA algorithm in the MAC architecture of a DNN is demonstrated below.

Removal of Symmetry by Shifting and Scaling: The FPoT alphabet is symmetric around zero by its definition. The weight distribution of a DNN often involves positive and negative values around zero, but the distribution of weight values may not be symmetric around 0. In order to apply the CCA as a non-uniform quantization to an arbitrary weight distribution, the present invention in one embodiment first applies shifting and scaling to the weights, and aligns the dynamic range of the shifted and scaled weights to the alphabet of FPoT, thereby producing the above noted quantized weights symmetric around 0. After FPoT based MAC computation, the results are scaled and shifted back to produce the desired result.

Below is a numerical example.
1. During training, obtain a DNN with weights w in a floating-point representation in between [−1, 0913, . . . , 1].
2. The FPoT alphabet is in between [0, . . . , 1.875],
3. First shift w to the right by IN′=W+1+3/32, where [0.0025, 2.0938],
4. Then scale w′ to fit into FPoT alphabet.
   W″=w′/18*16=(w+1+3/32)*(8/9), w=w″*(9/8)-1-3/32, w″ is [0.0022, 1.8611], which is a subset in FPoT.
5. Quantize w″ with CCA to get FPoT(w″).
6. Perform the first multiplication computation, which is x*w and which can be written as

x*w=x*(FPoT(w″)*(9/8)−1−3/32)=9/8×*FPoT(w″)−(1+3/32)*x
7. This multiplication applies to the full range of FPoT, w/o the need for symmetry assumptions in the weight distribution.
8. In general, the whole MAC computation can be written as

$$y = {\sum }_{k = 0}^{n - 1} {w}_{k} x = {\sum }_{k = 0}^{n - 1} {ax}_{k} FPoT ( {w}^{″} ) - {bx}_{k} = a {\sum }_{k = 0}^{n - 1} {x}_{k} FPoT ( {w}^{″} ) - b {\sum }_{k = 0}^{n - 1} {x}_{k}$$

In one embodiment of the present invention, the scaling can be applied once after the accumulation of the results following the multiplication with the FPoT alphabet. As a result, the shift can be done efficiently. With the scaling and shifting of the weight values using the quantized weight criterion described above, the CCA can work to produce FPoT-derived values from any arbitrary weight distribution without the need for the initial weight distribution to be symmetric.

In some embodiments, the deep neural network may be implemented as a system on a chip (SoC) in order to get for example an estimate of error information (i.e., FBC value) in a relatively short period of time, i.e., low latency. The controller 100 of FIG. 2 may use the SoC-implemented deep neural network. For example, firmware (FW) of the controller 100 may be programed to use a subset of floating-point values to represent weights in the DNN; quantize the floating-point values onto a flexible-power-of-two (FPoT) alphabet; list values (possibly all values) in the FPoT alphabet in a plurality of regions; and merge each empty region among the plurality of regions to neighbour regions to output clusters of the weights in merged regions, the merged regions having respective centroids and boundary lines in between.

Regardless of implementation, in one embodiment of the present invention, FIG. 11 depicts a method for operating a deep neural network (DNN) according to one embodiment of the invention. At 1101, the method uses a subset of floating-point values to represent weights in the DNN. At 1103, the method quantizes the floating-point values onto a flexible-power-of-two (FPoT) alphabet, At 1105, the method lists values (possibly all values) in the FPoT alphabet in a plurality of regions, At 1107, the method merges each empty region among the plurality of regions with neighbour regions to output clusters of the weights in merged regions, the merged regions having respective centroids and boundary lines in between (such as shown in FIG. 10A)

In this method for operating a DNN, the respective centroids and boundary lines of the merged regions may be formed by a constrained clustering algorithm consolidating the clusters of the weights in the DNN into a reduced number of clusters. This method may further provide the centroids and boundary lines for the reduced number of clusters to the DNN. This method may further list all values in the FPoT alphabet in the plurality of regions. This method may further merge each empty region among the plurality of regions with a neighbor region.

In this method for operating a DNN, the merging may be done by identifying a best region, out of two adjacent neighbor regions, to merge with the empty region; identifying a best direction to merge the best region; and merging the best region in the best direction, Identifying a best region may comprise re-adjusting quantized values of the floating-point values produced in the quantizing to reduce a mean square error in the merged regions.

In this method for operating a DNN, the using a subset of floating-point values may comprise scaling and shifting the floating-point values of a general weight distribution of the weights in the DNN to provide a symmetric weight distribution.

In this method for operating a DNN, non-empty regions among the plurality of regions may be merged with respective neighbor regions for example by identifying a best region, out of two adjacent neighbor regions, to merge with the non-empty region; identifying a best direction to merge the best region; and merging the best region in the best direction.

In another embodiment of the present invention, there is provided a memory system for operating a deep neural network (DNN). The memory system in this embodiment includes a data source; and a controller configured to calculate parameters corresponding to the DNN, wherein the controller is programmed to: use a subset of floating-point values to represent weights in the DNN, quantize the floating-point values onto a flexible-power-of-two (FPoT) alphabet, list values in the FPoT alphabet in a plurality of regions, and merge an empty region among the plurality of regions to neighbor regions to output clusters of the weights in merged regions, the merged regions having respective centroids and boundary lines in between.

In this memory system, the respective centroids and boundary lines of the merged regions may be formed by a constrained clustering algorithm consolidating the dusters of the weights in the DNN into a reduced number of clusters. In this memory system, the controller may be programmed to provide the centroids and boundary lines for the reduced number of clusters to the DNN. In this memory system, the controller may be programmed to list all values in the FPoT alphabet in the plurality of regions.

In this memory system, the controller in this embodiment may be programmed to merge each empty region among the plurality of regions with a neighbor region. The controller in this embodiment where an empty region is merged may be programmed to identify a best region (out of two adjacent neighbor regions) to merge with the empty region, identify a best direction to merge the best region, and merge the best region in the best direction.

In this memory system, the controller may be programmed to re-adjust quantized values of the floating-point values produced in the quantizing to reduce a mean square error in the merged regions. The controller may also be programmed to scale and shift the floating-point values of a general weight distribution of the weights in the DNN to provide a symmetric weight distribution.

In this memory system, the controller in this embodiment may be programmed to merge non-empty regions among the plurality of regions with respective neighbor regions. The controller in this embodiment where non-empty regions are merged may be programmed to: identify a best region (out of two adjacent neighbor regionsI to merge with the non-empty region, identify a best direction to merge the best region, and merge the best region in the best direction.

In one embodiment of the present invention, a DNN utilizing the inventive CCA algorithm in the MAC architecture has application in bit flop decoding by predicting the performance of a BF decoder in a noisy or otherwise changing set of operational conditions, and thus can be applied to the BF decoder 630 or BF encoder 650 shown in FIG. 6 to improve correction performance of a BF decoder.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives that fall within the scope of the claims.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives of the disclosed embodiment. Furthermore, the disclosed embodiments may be combined to form additional embodiments.

Indeed, implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a nodule, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code), A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices, Computer readable media suitable for storing computer program instructions and data include all forms of non-volatile me lory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions, Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be excised from the combination, and the combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for operating a deep neural network (DNN), comprising:
using a subset of floating-point values to represent weights in the DNN;
quantizing the floating-point values onto a flexible-power-of-two (FPoT) alphabet;
listing values in the FPoT alphabet in a plurality of regions; and
merging an empty region among the plurality of regions to neighbor regions to output clusters of the weights in merged regions, the merged regions having respective centroids and boundary lines in between.

2. The method of claim 1, wherein the respective centroids and boundary lines of the merged regions are formed by a constrained clustering algorithm consolidating the clusters of the weights in the DNN into a reduced number of clusters.

3. The method of claim 2, further comprising providing the centroids and boundary lines for the reduced number of clusters to the DNN.

4. The method of claim 1, wherein the listing values in the FPoT alphabet comprises listing all values in the FPoT alphabet in the plurality of regions.

5. The method of claim 1, wherein the merging comprises merging each empty region among the plurality of regions with a neighbor region.

6. The method of claim 1, wherein the merging comprises:
identifying a best region, out of two adjacent neighbor regions, to merge with the empty region;
identifying a best direction to merge the best region; and
merging the best region in the best direction.

7. The method of claim 1, wherein the identifying a best region comprises re-adjusting quantized values of the floating-point values produced in the quantizing to reduce a mean square error in the merged regions.

8. The method of claim 1, wherein the using a subset of floating-point values comprises:
scaling and shifting the floating-point values of a general weight distribution of the weights in the DNN to provide a symmetric weight distribution.

9. The method of claim 1, further comprising merging non-empty regions among the plurality of regions with respective neighbor regions.

10. The method of claim 9, wherein the merging non-empty regions comprises:
identifying a best region, out of two adjacent neighbor regions, to merge with the non-empty region;
identifying a best direction to merge the best region; and
merging the best region in the best direction.

11. A memory system for operating a deep neural network (DNN), comprising:
a data source; and
a controller configured to calculate parameters corresponding to the DNN, wherein the controller is programmed to:
use a subset of floating-point values to represent weights in the DNN;
quantize the floating-point values onto a flexible-power-of-two (FPoT) alphabet;
list values in the FPoT alphabet in a plurality of regions; and
merge an empty region among the plurality of regions to neighbor regions to output clusters of the weights in merged regions, the merged regions having respective centroids and boundary lines in between.

12. The system of claim 11, wherein the respective centroids and boundary lines of the merged regions are formed by a constrained clustering algorithm consolidating the dusters of the weights in the DNN into a reduced number of dusters.

13. The system of claim 12, wherein the controller is further programmed to provide the centroids and boundary lines for the reduced number of clusters to the DNN.

14. The system of claim 11, wherein the controller is further programmed to list all values in the FPoT alphabet in the plurality of regions.

15. The system of claim 11, wherein the controller is further programmed to merge each empty region among the plurality of regions with a neighbor region.

16. The system of claim 11, wherein the controller is further programmed to:
identify a best region, out of two adjacent neighbor regions, to merge with the empty region;
identify a best direction to merge the best region; and
merge the best region in the best direction.

17. The system of claim 11, wherein the controller further programmed to re-adjust quantized values of the floating-point values produced in the quantizing to reduce a mean square error in the merged regions.

18. The system of claim 11, wherein the controller is further programmed to scale and shift the floating-point values of a general weight distribution of the weights in the DNN to provide a symmetric weight distribution.

19. The system of claim 11, wherein the controller is further programmed to merge non-empty regions among the plurality of regions with respective neighbor regions.

20. The system of claim 19, wherein the controller is further programmed to:
identify a best region, out of two adjacent neighbor regions, to merge with the non-empty region;
identify a best direction to merge the best region; and
merge the best region in the best direction.
